(19) United States
(12) Patent Application Publication
(10) Pub. No.: US 2006/0099115 A1
(43) Pub. Date: May 11, 2006

(54) Pipette device

(75) Inventor: Marten Sandberg, Stockholm (SE)

Correspondence Address: HAYNES AND BOONE, LLP, 901 MAIN STREET, SUITE 3100, DALLAS, TX, 75202, US

(73) Assignee: Precision System Science Co., Ltd., Chiba (JP)

(21) Appl. No.: 10/534,672

(22) PCT Filed: Jul. 18, 2003
(86) PCT No.: PCT/SE03/01228

§ 371 Date: May 12, 2005

(30) Foreign Application Priority Data
Nov. 14, 2002 (SE) 0203366-0

(51) Int. Cl. B01L 3/02

(52) U.S. Cl. 422/100

(57) ABSTRACT

A pipetting arrangement comprising a carrier (10) to which first ends of a plurality of mutually parallel nozzles (20) are connected with the aid of respective screw joints (21, 22), wherein the nozzles are spaced only a slight distance apart, wherein second ends (24) of said nozzles (20) are designed to carry a readily replaced pipetting tip (30), and wherein the pipetting arrangement also includes means (7, 8, 17, 18, 12) for establishing at said second end of a respective nozzle (20) a selective pressure for sucking fluid into and dispensing fluid from said tips. The nozzles are provided at their respective second ends (24) with a driving formation (28, 28′) to which there can be applied a turning tool for respectively tightening and loosening the screw joint (21, 22).

The present invention relates to a pipetting arrangement of the kind defined in the preamble of claim 1.

A pipetting arrangement of this kind is known from GP 1136127 A. The pipetting arrangement includes a carrier to which first ends of respective nozzles in a plurality of mutually parallel nozzles are connected with the aid of a respective screw joint, wherein the nozzles are spaced only a slight distance apart, and wherein second ends of said nozzles are designed to carry a readily replaced pipetting tip. The pipetting arrangement also includes means for establishing at said second end a selectable pressure for sucking fluid into and dispensing fluid from said tips. The carrier can be rotated to enable the tips to be inserted into respective fluid volumes for the suction of fluid therefrom.

One problem with this type of pipetting arrangement is that the nozzles must be situated tightly adjacent one another, for space reasons. To enable the establishment of respective releasable screw joints to be achieved, each nozzle has around its periphery in the proximity of the screw joint an hexagonal fitting which enables the nozzle to be rotated with the aid of an hexagonal wrench or some corresponding tool. A nozzle that malfunctions must be replaced. However, because the nozzles lie so close together it is not normally possible to grip a nozzle that is situated inwardly of a nozzle row. Consequently, it will be necessary for an operator to remove a number of nozzles in turn, starting from the end of at least the row in which the malfunctioning nozzle is situated. It may be necessary to remove nozzles from several rows, starting from their respective ends, before the malfunctioning nozzle can be reached and replaced. After the malfunctioning nozzle has been replaced, the nozzles that were dismantled must be replaced. The problem becomes particularly troublesome when the nozzles are disposed very close together in a matrix that includes several parallel rows of nozzles. However, the problem is also troublesome in the case of apparatus that include only a single row of nozzles.

The object of the present invention is to provide a pipetting arrangement with which a single malfunctioning nozzle can be readily replaced without requiring closely situated functioning nozzles to be dismantled and re-fitted as a result thereof.

This object is achieved by means of the present invention.

The invention is defined in the accompanying claim 1.

Other embodiments of the present invention will be apparent from the accompanying dependent claims.

Basically, the present invention involves providing the second ends of the nozzles with a respective driving formation to which a nozzle turning tool can be applied axially without being obstructed by nearby nozzles. The tool can then be rotated to loosen or tighten the screw joint of the nozzle concerned.

The driving formation on the second end is preferably centred coaxially on the nozzle. The driving formation may consist in an end-groove in an axial plane to the nozzle, so as to enable the nozzle to be driven by a flat-headed screwdriver. Alternatively, the driving formation may consist in a crosscut groove which is centred in relation to the nozzle axis and which can be driven by a cross-mouthed driver. Analogous driving formations and driving tools will be obvious to the person of average skill in this art.

Since the nozzle narrows conically from its second end down towards the extremity of said end with a total front rake angle of five (5) degrees, for instance, over a length of seven (7) mm for instance, the risk of the driving tool interfering with nearby nozzles when fitting or dismantling nozzles is minimised. The conicity of a nozzle enables a corresponding conical end-part of a nozzle tip of the pipetting arrangement to be readily fastened.

The invention will now be described by way of example with reference to the accompanying drawings, in which

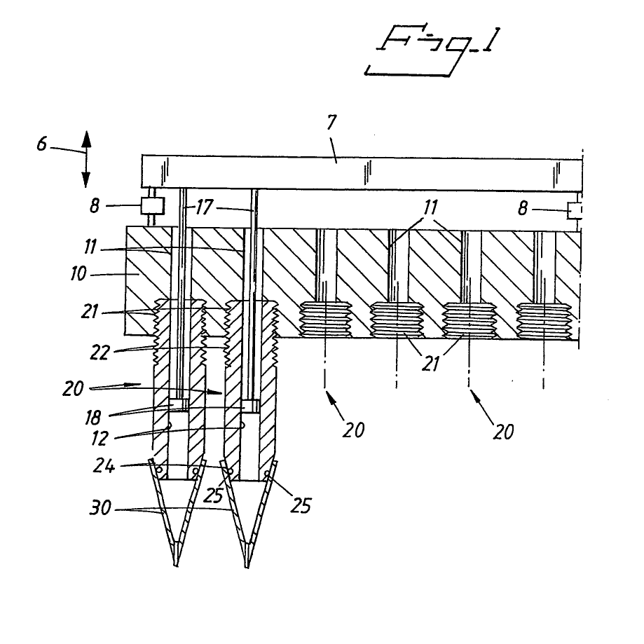

FIG. 1 is a schematic partially sectioned view of a pipetting arrangement;

FIG. 2 is a perspective reproduction of a tubular nozzle for an arrangement constructed in accordance with the present invention;

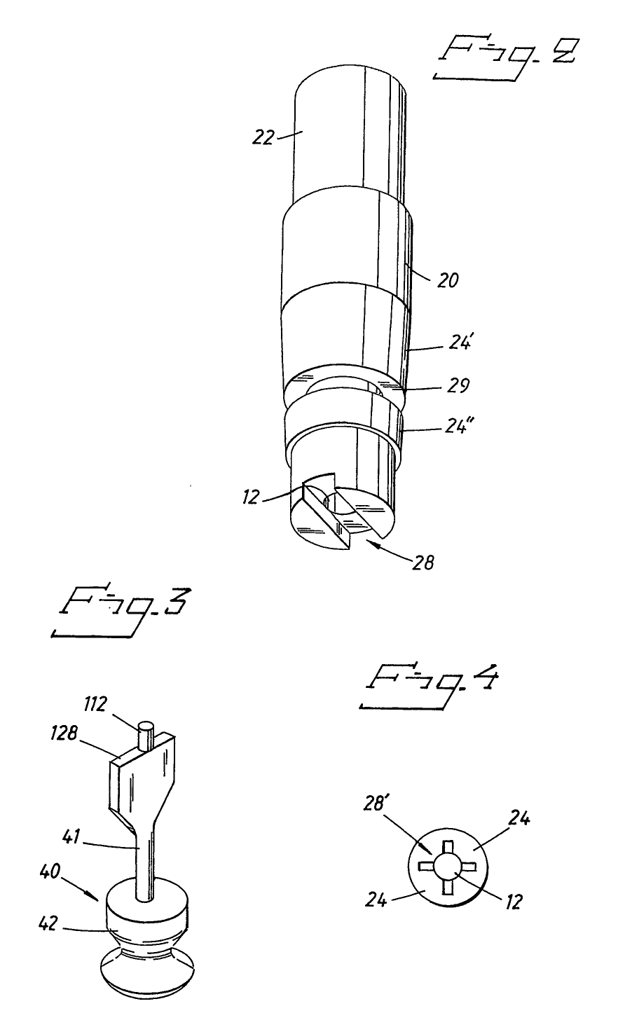

FIG. 3 illustrates schematically a tool for rotating the nozzle shown in FIG. 2; and

FIG. 4 is an end view of another embodiment of the nozzle.

FIG. 1 shows a carrier 10 which is provided with a row of mutually parallel through-penetrating bores 11 that have on the under side of the carrier a widened section which includes an internal screw thread 21. A tubular nozzle 20 has on its first end an external screw thread 22 which co-acts with the internal thread 21. The nozzle 20 has a central passageway 12 which corresponds to the passageway or through-penetrating bore 11. A piston rod 17 carries a piston 18 which is received in the passageway 12 and can be drawn out through the passageway 11. The lower second end 24 of the nozzle narrows conically for receiving a pipetting tip 30, which must be frequently replaced.

The piston rod may have the same diameter as the piston. This enables the carrier 10 to be formed by two mutually affixed plates that have mutually aligned openings corresponding to the bores/passageways 11, wherein the plates have contact surfaces that lie generally in a plane normal to the axes of said passageways, and wherein at least one of the contact surfaces includes a recess for accommodating a sealing ring (an O-ring) that seals against the piston rod/piston.

The piston rods 17 are carried by a displaceable bar 7 which can be moved relative to the carrier 10 and parallel therewith, such as to draw a volume of fluid into the tips 30 when the piston is withdrawn and to dispense a volume of fluid when the piston 18 is driven down.

In an embodiment at present preferred (FIG. 2), the conical section 24 of the nozzle 20 includes two axially spaced annular conical parts 24′, 24″, these annular parts being separated by a peripheral groove 29 for accommodating a sealing ring 25, e.g. an O-ring, which provides a seal around a tip 30, e.g. a plastic tip. The free end part of the nozzle 20 is purely cylindrical. The recess is replaced with a screw driver slot 8 in the axial plane of the nozzle at its free end.

A driver 40 (FIG. 3) has a blade 128 which fits into the slot 28. As shown, the blade may carry a pin 112 that is received in the passageway 12. As shown in FIG. 3, the driver 40 may include a handle 42 connected to the blade 128 by means of a shank 41.

When a tip 30 is removed from the conical part of a nozzle, the blade 128 of the driver 40 can be inserted into the groove coaxially with the nozzle 20, so as to loosen or establish respectively the screw joint 21, 22.

FIG. 4 illustrates schematically an alternative to the groove 28, in the form of a cruciform groove 28′ which is centred in relation to the axis of the nozzle 20 and which accommodates the blade of a cross-headed driver.

The carrier 10 is displaceable relative to a microtitration plate, so that the tips 30 can be respectively inserted into and raised from the basins in said plate. The means for moving the carrier (the nozzles 20) in relation to the microtitration plates form no part of the invention and will not therefore be described in detail.

It will also be understood that devices other than the pistons 18 and their drive means may be provided to establish a subpressure and an overpressure in the passageway 12 at the free end of the nozzle. For instance, a central overpressure and subpressure source may be connected respectively to the free ends of the nozzles 20 for sucking and dispensing fluid into and from the tips 30, 40.

The pipetting tips 30 are of a conventional design and suitably have the form of a conical rotational-symmetrical shell which at its larger end has essentially the same conicity as the conical end part 24 of the nozzle 20.

The fact that the end part 24 narrows towards its tip enables the driving formation to be established alternatively around the periphery of said end part, since a tool co-acting therewith, for instance a socket wrench, may also in practice have an outer diameter which is smaller than the pitch between mutually adjacent nozzles, and may also have a diameter that is smaller than the outer diameter of said nozzles when adjacent nozzles are in radial contact with each other.

1. A pipetting arrangement that includes a carrier (10) to which first ends of a plurality of mutually parallel nozzles (20) are connected with the aid of respective screw joints (21, 22), wherein the nozzles are spaced only a slight distance apart, wherein second ends (24) of said nozzles (20) are designed to carry a readily replaced pipetting tip (30), and wherein the pipetting arrangement also includes means (7, 8, 17, 18, 12) for establishing at said second end of a respective nozzle (20) a selective pressure for sucking fluid into and dispensing fluid from said times, characterised in that the nozzles are provided at their respective second ends (24) with a driving formation (28, 28′) to which there can be applied a turning tool for respectively tightening and loosening the screw joint (21, 22).

2. An arrangement according to claim 1, characterised in that the driving formation (28) includes a groove on the free end of the nozzle in the axial plane thereof, wherein the tool includes a blade that co-acts with the groove.

3. An arrangement according to claim 1, characterised in that the driving formation (28′) is a cross-shaped groove which is centred with respect to the axis of the nozzle (20), wherein the tool includes a cross-headed blade for co-action with the cross-shaped groove (28′).

4. An arrangement according to claims 1-3, characterised in that the nozzle (20) has adjacent its second end a narrowing end portion (24) to which a tip (30) can be tightly and removable attached.

5. An arrangement according to claim 4, characterised in that the end portion (24) of the nozzle has a peripheral groove (29) which carries a sealing ring (25) which seals against the inner circumference of the pipetting tip (30).
